(19) United States
(12) Patent Application Publication
(10) Pub. No.: US 2015/0318888 A1
(43) Pub. Date: Nov. 5, 2015

(54) Protective case for portable electronic device

(71) Applicant: Guan Zhang, Leipzig (DE)

(72) Inventor: Guan Zhang, Leipzig (DE)

(21) Appl. No.: 14/694,108

(22) Filed: Apr. 23, 2015

(30) Foreign Application Priority Data
Apr. 25, 2014 (DE) DE202014101951.0

(51) Int. Cl. H04B 1/3888

(52) U.S. Cl. CPC H04B 1/3888

(57) ABSTRACT

A protective case for a portable electronic device that is composed of two linked protective cover panels. The first panel is to carry the device and the second has an adjustable fastener on the internal side. The adjustable fastener consists of two parts which are connected to and can be parted from each other.

### FIELD OF THE INVENTION

This invention generally relates to protecting covering for portable electronic devices. In particular this invention relates to a carrying case for protection, transport, storage and use of portable electronic devices.

### BACKGROUND OF THE INVENTION

Electronic devices such as tablet computers, smartphones, e-readers etc. offer many different functions; they are light and portable but also fragile. Such electronic portable devices are easily damaged, especially their displays, camera objectives and circuits. It is common to carry this kind of electronic device in special protective cases.

It would be profitable to offer a carrying case for such portable devices that incorporates the best features of the known previous cases and improves upon them. Such carrying case would provide not only safe carrying, transporting and storing of the portable electronic device. It would allow the optimal handling of the devices with easy use of all their operating functions in almost every environment and position where there is a suitable object to attach it to.

### BRIEF SUMMARY OF THE INVENTION

The present invention relates to a case for a portable electronic device. This case comprises of two protective covers connected to each other. A first cover provides fixing of the portable electronic device and a second cover comprises an adjustable fastener on the inner surface, wherein the adjustable fastener consists of two parts which are detachably connected to each other. The first cover and the second cover are connected to each other.

The case is particularly suitable for the reception of portable electronic devices that have a monitor or display, such as smart phones, tablet PCs, flat screens, CD players, DVD players, video game consoles, and flat screen TVs. The case protects the portable electronic device and allows the user to see the information on the screen and operate this device, without having to remove it from the case. The adjustable fastener allows the attachment of this case with the device inside to different body parts, items and appliances, wherein the adjustable fastener can be customized to different diameters of the body parts, objects or devices.

### DETAILED DESCRIPTION OF THE INVENTION

The invention generally relates to a case for a portable electronic device which is comprised of a first and a second cover, where those two covers are connected and wherein one of the two covers has an adjustable fastener on the inside that consists of two parts. The outer shape of the first and the second cover preferably match the external shape of the portable electronic device. In a particularly preferred design, the first and the second cover are rectangular. In an even further preferred design, the first cover serves to accommodate the electronic device and the adjustable fastener is located on the inside of the second cover. Particularly suitable for the purposes of the invention is a case for a portable electronic device, wherein the first cover can be folded onto the second cover.

In one design, the invention relates to a case for a portable electronic device, comprising a first rectangular cover and a second rectangular cover, whereby the first rectangular cover and the second rectangular cover are connected and wherein one of the two rectangular covers has a clasp on the inside, which consists of two overlapping parts that are detachably connected. The case according to the invention may further comprise a method for setting up the portable electronic device in the case, wherein this method for setting up the portable electronic device is preferably integrated in the case. The integrated means for setting up the portable electronic device enables the setting up of the portable electronic device in the case without the user having to carry a separate stand. By integrating the means for setting up the portable electronic device as part of the case, the case has additional functionality and user-friendliness. Since the means for setting up the portable electronic device is integrated in the case, the means for setting up the portable electronic device is always immediately available with the case and cannot be lost, as it would be possible, for example, with a separate stand.

The first rectangular cover of the case according to the invention comprises one or more means which are used to attach the portable electronic device to the case. All conventional means which can be used for attachment are suitable as a means for attaching the portable electronic device in the case. This may, for example, be fastener means that are attached to all four corners of the first rectangular cover of the casing and with which the portable electronic device can be easily attached in a way that the screen of the portable electronic device remains visible and the reverse side of the portable electronic device is directed to the inside of the first rectangular cover of the case.

In another design, the first rectangular cover may be formed as a pocket into which the portable electronic device can be inserted. Such a first rectangular cover that is designed as a case has a first, second, third and fourth side on the inside, which form a frame and wherein the first and third sides are longer than the second and the fourth side. One of the four sides comprises an opening through which the portable electronic device can be inserted into the case as well as an optional fastener, which is detachable, to securely fasten the portable electronic device in the case. Furthermore, the first rectangular cover that is designed as a case comprises on the inside a rectangular opening, through which the screen of the portable electronic device remains visible.

In another design, the frame on the inside of the rectangular cover designed as a case may be made of an elastic material that makes it possible to stretch the frame so that the portable electronic device can be inserted into and taken out from the case without trouble.

For the purposes of this invention, all cases for portable electronic devices are suitable that comprise a first, preferably rectangular, and a second, preferably rectangular, cover, wherein the first and the second cover are connected.

According to the invention, the case for portable electronic devices is particularly characterized by a fastener which is located on the inside of one of the two rectangular covers and that consists of two parts, which are detachably connected.

In a particularly preferred design, the fastener consisting of two parts is located on the inner side of the second rectangular cover which is not intended to accommodate the portable electronic device.

In a particularly preferred design, the fastener on the inner side of the second rectangular cover is made of two band-like parts which overlap and are detachably connected.

The two-piece fastener on the inside of the second rectangular cover allows for a very comfortable positioning and handling of the case under various conditions of everyday life. Thus, the two-piece detachable fastener on the inside of the second rectangular cover can be used to attach the case to body parts, objects or devices.

Preferably, the two parts of the two-part detachable fastener on the inside of the second rectangular cover form two parts of a hook and loop fastener. For the purposes of the case according to the invention, any type of conventional hook and loop fastener is suitable.

In a particularly preferred design, the two parts of the two part fastener on the inside of the second rectangular cover can each be connected via an elastic connector to the inside of the second rectangular cover of the case for the portable electronic device. These elastic connectors serve to make the two otherwise non-elastic parts of the fastener, for example a hook and loop fastener, on the one hand flexibly foldable and to on the other hand increase the flexibility and extensibility of the two-part fastener when attaching the case according to the invention to parts of the body, objects or devices, which have different diameters.

In a preferred design, the invention provides a case for a portable electronic device comprising a first rectangular cover 10 and a second rectangular cover 20, wherein the first rectangular cover 10 and the second rectangular cover 20 are connected. The first rectangular cover 10 has several erect edges (11, 12, 13, 14, and optionally 15, 16) where the edges' rims are curved and directed towards the inside of the first rectangular cover 10. Preferably, the first rectangular cover 10 has four such upright edges 11, 12, 13 and 14 with a bent rim directed towards the inside. In a particularly preferred design, the upright edges 11, 12, 13 and 14 with a curve rim directed towards the inside of the first rectangular cover 10 are each placed at one corner of the first rectangular cover 10. In particular, these upright edges 11, 12, 13 and 14 serve to accommodate the portable electronic device 30 and secure it in the case. The curved edges facing the inside of the first rectangular cover 10 of the upright edges 11, 12, 13 and 14 are designed so that a portable electronic device 30 can be inserted into the first rectangular cover 10 with little effort and as simply as possible. The first rectangular cover 10 may optionally comprise the additional upright edges 15, 16 on the short sides of the cover. They function as a more secure attachment of a portable electronic device, especially if it is a larger portable electronic device such as a DVD player or a flat screen.

The upright edges 11, 12, 13, 14 and optionally 15 and 16 only cover minor portions of the four sides of the portable electronic device. The remaining areas stay accessible from all sides. This has the advantage that operating elements such as on-off switches, connections (like USB, power supply, headphones, etc.) and other devices such as speakers are freely accessible without having to remove the electrical device 30 from the case.

The case according to the invention is characterized by a second rectangular cover 20 that comprises an adjustable fastener 21 on the inside, which consists of two band-like overlapping parts 22 and 23 that are detachably connected.

The external shape and dimensions of the first rectangular cover 10 and the second rectangular cover 20 are preferably adapted so that they match the outer shape of the respective portable electronic device 30. The height of the upright edges 11, 12, 13, 14 and optionally 15 and 16, especially the space between the inside of the first rectangular cover and the bottom of the curved edges facing the inside of the first rectangular cover 10, preferably corresponds to the height or the thickness of the portable electronic device 30 that is to be combined with the case.

In a preferred design, the first rectangular cover 10 is divided in two and comprises a back part 17 that comprises the upright edges 11, 12, 13, 14 and optionally 15 and 16 with their curved edges facing inside as well as a quadrangular, preferably rectangular, a quadratic, or trapezoidal cut-out. In a particularly preferred design, back part 17 includes a cut-out that has the shape of an isosceles trapezoid. If the first rectangular cover 10 is divided in two, it preferably comprises a connecting element 40, whereby the external shape and dimensions of this connecting element 40 are designed to fill out the square cut-out of back part 17 as closely as possible. In particular, this connecting element 40 serves to fastener back part 17 to the second rectangular cover 20. In a particularly preferred design, the connecting element 40 is designed to comprise a first hinge 41 and second hinge 42. It is particularly preferred, if the first hinge 41 and second hinge 42 are constructed as a fold. This makes it possible to manufacture the case according to the invention from a uniform material or the same materials.

The two-piece fastener 21 on the inside of the second rectangular cover 20 as well as the first hinge 41 and second hinge 42 at the connecting element 40 allow for a very comfortable attachment and handling of the shell, with or without but preferably with a portable electronic device 30, under a variety of conditions of daily life. Thus, the two-piece detachable fastener 21 on the inside of the second rectangular cover 20 can be used to attach the case according to the invention to body parts, items or devices.

In a preferred design, the two parts 22 and 23 of the fastener 21 each have an elastic connection element 24. This elastic connection element is preferably a rubber band. This elastic connection element 24 serves to make the two otherwise non-elastic parts 22 and 23 of the fastener 21 flexibly foldable.

The case according to the invention may be attached to parts of the body, objects or devices by means of the fastener 21 that comprises the parts 22 and 23 and possibly the two elastic parts 24. The particular advantage of the fastener 21 is that the two parts 22 and 23 may be connected variably, and thus the fastener is adjustable to parts of the body, objects or devices with a varying circumference.

In a most preferred design, the two parts 22 and 23 form two parts of a hook and loop fastener. For the purposes of the case according to the invention, any type of conventional hook and loop fastener is suitable.

For fastening the case, for example to a part of the body such as a hand, the back part of the second rectangular cover 20 is folded onto the back part of the first rectangular cover 10, so that the fastener 21 is directed towards the outside. Now, the closed case according to the invention can be slid over the hand with the help of the fastener 21. Due to the flexible attachment of the connecting element 40 by means of the two hinges 41 and 42, it is possible that the user can carry the case according to the invention located in the hand without soiling the display of the portable electronic device 30 with the fingers of the hand that carries the device. In the same way, the case may be attached to objects or devices with the help of the infinitely adjustable fastener 21. Particularly preferred is the attachment of the case according to the invention to the headrest 60 on the back of the front seats of a motor vehicle such as a passenger car. Thus, during longer trips passengers in the rear seats of the vehicle may, for example, watch videos/movies, watch/play DVDs or listen to CDs, communicate with other people (e.g. via video telephony), exchange emails with the help of the electronic device 30 or to use the electronic device for playing games.

When the case is, for example, attached to a part of the body, such as a hand, the two elastic connecting elements 24 provide a more comfortable feeling for the user (of the case). If the case according to the invention is attached to an object or device, as for example the headrest 60 of a motor vehicle, the flexible connecting elements 24 enable the balancing of shakes during operation of the motor vehicle and thus lead to a better protection from knocks and bumps, which can occur during the operation of a motor vehicle, of the portable electronic device 30 in the case. In another design, the case according to the invention may comprise a stretchable, preferably elastic, band 27 on the inside of the second rectangular cover 20. This stretchable, preferably elastic, band 27 may be, for example, a rubber band. The stretchable band 27 may be used as an additional safety device during transportation when the portable electronic device 30 is in the case according to the invention.

In a preferred design, the inside of the second rectangular cover 20 comprises at least one, preferably several, and more preferably two groove-shaped indentations 25 and/or 26.

The second rectangular cover 20 may comprise at least one upright edge 28, which has a curved rim directed towards the inside of the second rectangular cover 20. At least one upright edge 28 serves as a seal between the first rectangular cover 10 and the second rectangular cover 20, when the case according to the invention is used when closed. The upright edge 28 is slipped over the outer edge of the electronic device 30 and by that fastens the second rectangular cover 20 to the first rectangular cover 10, which accommodates the portable electronic device 30. The (resulting) connection is strong enough to ensure a safe transport and the protection of the portable electronic device 30. At the same time, this type of connection is easily detachable so that the user can open the case according to the invention without much effort.

In a particularly preferred design of the case according to the invention, the first rectangular cover 10 is foldable onto the second rectangular cover 20 and the stretchable band 27 can be tightened over the outer side of the first rectangular cover 10 as a safety device during transportation.

In a further preferred design, the first rectangular cover 10 and the second rectangular cover 20, respectively, are foldable to each other's reverse sides. In this case, the stretchable band 27 can, as a safety device during transportation, be tightened over a corner of the portable electronic device 30 that is in the first rectangular cover 10.

In another design, the case according to the invention can be used together with the portable electronic device 30 in an upright position. In this case, back part 17 can be positioned by means of the connecting element 40 and the two hinges 41 and 42, that the lower edge of the back part 17 and the corresponding rim of the electronic device 30 are received in one of the groove-shaped indentations 25 or 26. The advantage of this is that the display of the portable electronic device 30 can be positioned at different angles and thus the mounting angle can be adapted to the requirements of the user. The angle of the portable electronic device 30 can also be varied so as to avoid or reduce the blinding effect of the incident light.

In a particularly preferred design, the first rectangular cover 10 or the back part can have one or more openings 50 for additional functions and/or control elements of the portable electronic device 30. These may be, for example, an on-off switch, built-in cameras, flashlights, an internal microphone, etc.

The case according to the invention may be made from any suitable synthetic or natural material. The case according to the invention may be made, for example, of plastic or imitation leather. Preferably, the case according to the invention is made from natural materials or a mixture of natural materials and synthetic materials. For high-quality designs of the case according to the invention, the outer sides of the first rectangular cover 10 or the back part 17 and the connecting element 40, and the second rectangular cover 20 are made from natural materials, such as leather, preferably smooth leather. The insides may be made from the same material as the outsides. However, the insides may also be made from another material such as a textile or a non-woven fabric. The fastener 21, in particular the two parts 22 and 23, can be manufactured from any conventional material. In particular the parts 22 and 23 can be made from conventional materials for hook-and-loop fasteners.

### BRIEF DESCRIPTION OF DRAWINGS

FIG. 1 shows the case according to the invention when opened, comprising a first rectangular cover 10 and a second rectangular cover 20. In the design shown here, the first rectangular cover 10 comprises a total of six upright edges, with their upper rims facing towards the inside of the first rectangular cover 10. The upright edges 11, 12, 13 and 14 are located at the corners of the first rectangular cover 10 and the upright edges 15 and 16 are located on the short outer sides of the first rectangular cover 10. The second rectangular cover 20 comprises a detachable fastener 21, which is designed as a hook and loop fastener, and consists of the two parts of the hook and loop fastener 22 and 23. With the help of the two parts 22 and 23, the fastener 21 can be adapted to varying diameters of objects, devices or parts of the body to which the case according to the invention is to be attached. The second rectangular cover 20 furthermore comprises two groove-shaped recesses 25 and 26, wherein the first groove-shaped recess 25 is formed from the front area of the second rectangular cover 20 and the area between the two groove-shaped recesses 25 and 26 have a greater thickness than the remaining areas of the second rectangular cover 20. The second groove-shaped recess is limited by the area of greater thickness between the groove-like recesses 25 and 26 and the fastener 21, especially when is closed. The second outer cover 20 further more comprises an upright edge 28 with a curved rim directed towards the inside of the second rectangular cover. The upright edge 28 functions as a closure when the case according to the invention is closed, i.e. when the inside of the second rectangular cover 20 is folded onto the display of the portable electronic device 30.

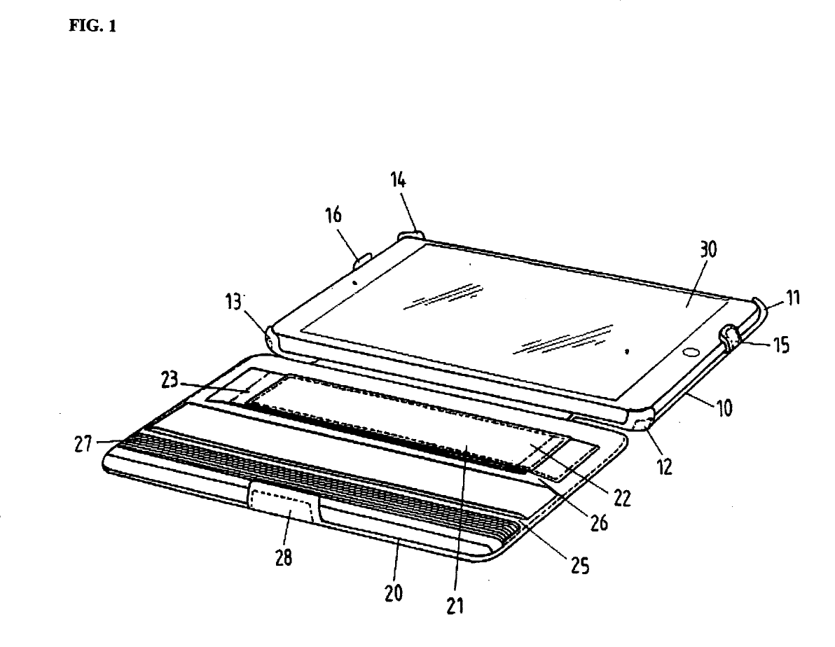

FIG. 2 shows a design of the case according to the invention without a portable electronic device. The first rectangular cover 10 consists of a back part and a connecting element 40, wherein the back part 17 is connected to the second rectangular cover 20 via the hinges 41 and 42 which are folded. Back part 17 includes four upright edges 11, 12, 13 and 14 with curved edges directed towards the inside for accommodating a portable electronic device. Back part 17 also includes an opening 50, for example for a camera that is located on the back of a tablet PC. Back part 17 also has a cut-out in the shape of an isosceles trapezoid which is filled out by the connecting element 40. FIG. 2 shows the fastener 21 with the two parts 22 and 23 when opened. In the design shown here, the two parts 22 and 23 respectively are connected via a rubber band 24 with the second rectangular cover 20. FIG. 2 also shows the two groove-shaped indentations 25 and 26 and the upright edge 28 with a curved rim directed to the inside of the second rectangular cover 20. The design of the case according to the invention shown in FIG. 2 contains an indentation at the same position of the first rectangular cover's outer edge which serves to better accommodate the upright edge 28 and thus an improved closure when the case according to the invention is closed.

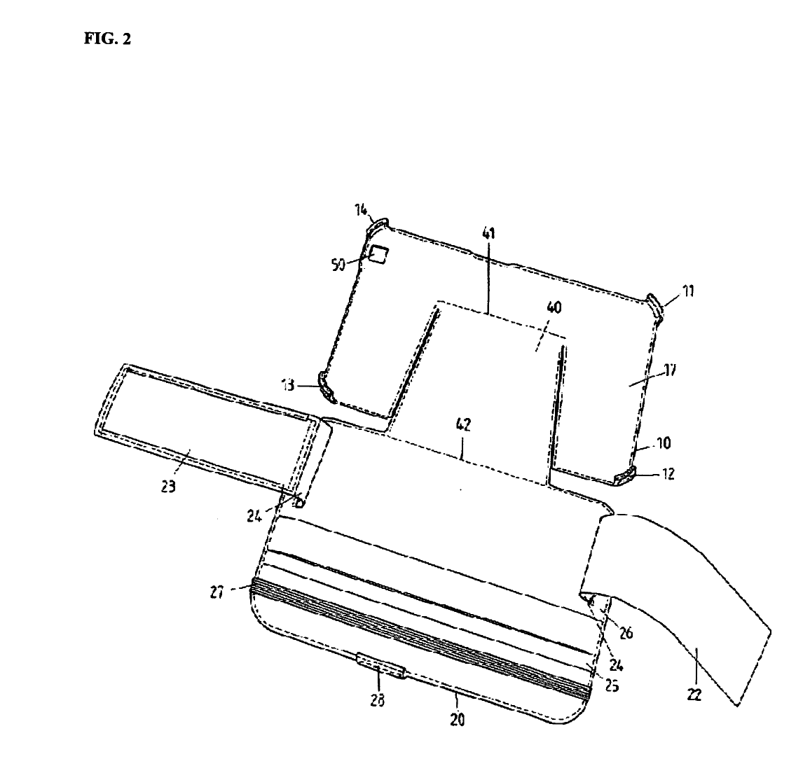

FIG. 3 shows the closed case according to the invention, comprising the first rectangular cover 10, the second rectangular cover 20, and further comprising a portable electronic device 30, wherein the case according to the invention is kept closed with the help of the upright edge 28.

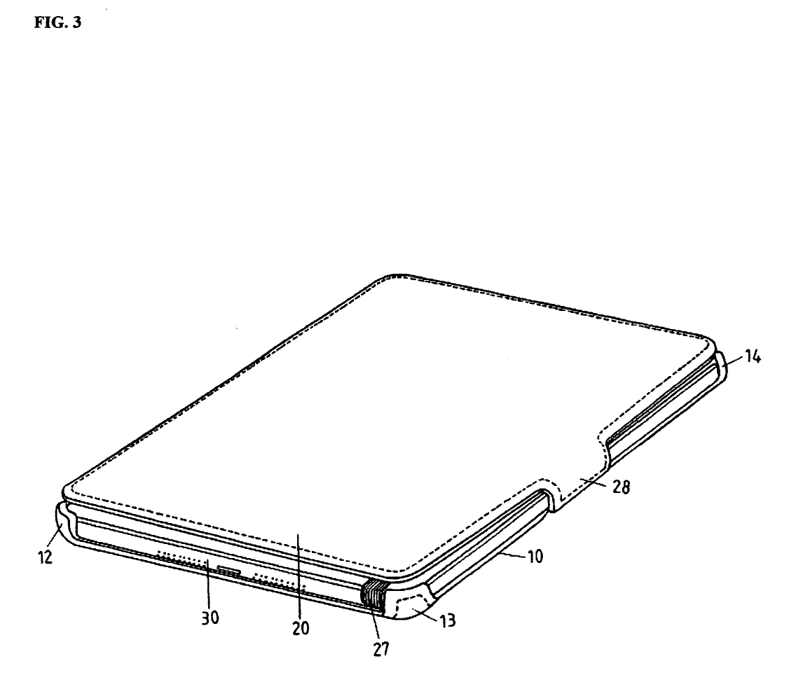

FIG. 4 illustrates the use of the case according to the invention in an upright position, comprising the portable electronic device 30, a back part 17, the connecting element 40 with the two hinges 41 and 42 which are folded, and the two groove-shaped indentations 25 and 26. As selected by the user, the lower edge of the back part 17 with the electronic device 30 can either be placed in the groove-shaped recess 25 or 26. This makes it possible to adjust the electronic device 30 at various angles and to make using it more comfortable.

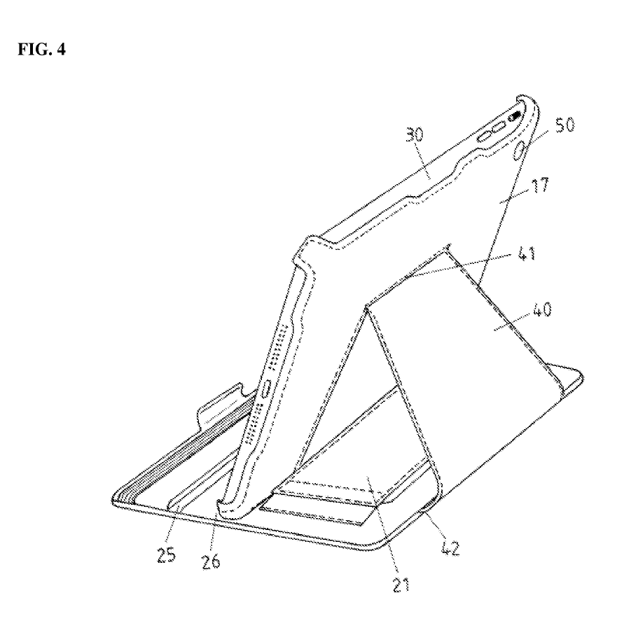

FIG. 5 shows the use of the case according to the invention, when it has been attached to a part of the body, as shown here to a hand. For this purpose, the back sides of the first rectangular cover 10 and the second rectangular cover 20 are folded on each other and the case according to the invention is attached to the hand of the user with the aid of the fastener, which is here indicated by the two parts 22 and 23. The thumb of the hand that carries the case according to the invention, is located under the back side of the electronic device 30. FIG. 5 shows that due to the design of the case according to the invention, it can be avoided, that the fingers of the hand carrying the device touch the display of the electronic device and thereby avoid the use of the electronic device 30 or soiling it can be prevented. As shown here, the stretchable band 27 was fastened over one corner of the electronic device 30 to secure it during transportation.

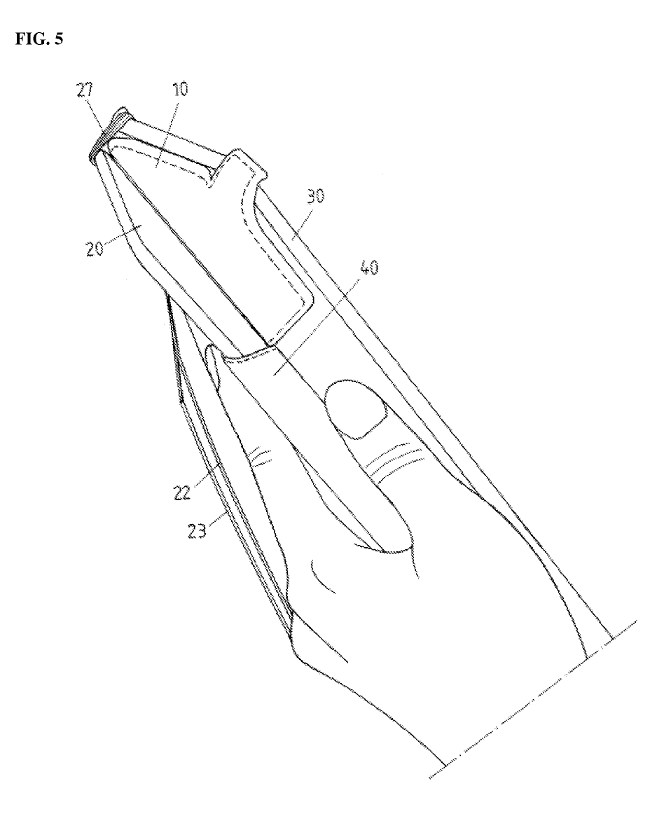

FIG. 6 illustrates the use of the case according to the invention in a motor vehicle. In the example shown, the case according to the invention was secured to the headrest 60 of a seat of a passenger car with the help of the two parts 22 and 23 of the fastener 21. For this purpose, the two reverse sides of the first rectangular cover and the second rectangular cover were at first folded on each other with the aid of the hinge 42. The electronic device 30 is held by means of the upright edges 11, 12, 13 and 14 in the first rectangular cover 10 of the case according to the invention.

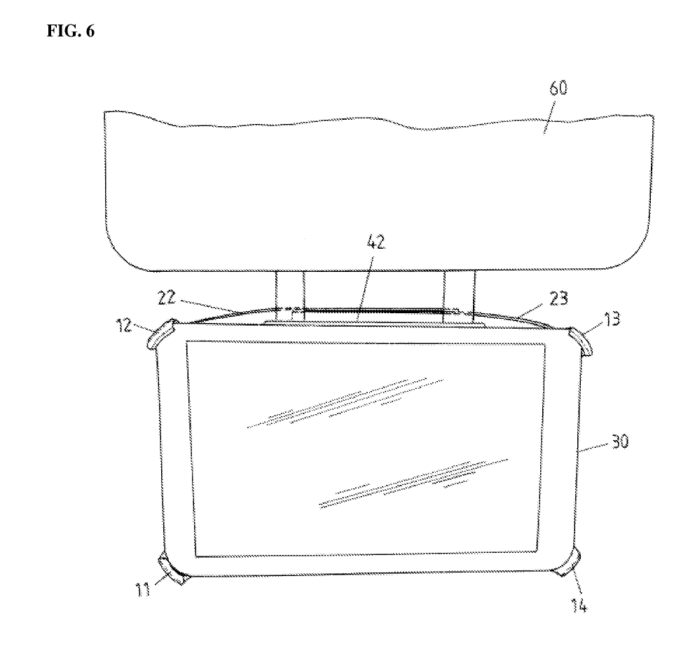

1. Case for a portable electronic device, comprising a first cover for accommodating the portable electronic device and a second cover with an adjustable fastener on the inside, wherein the adjustable fastener consists of two parts, which are detachably connected, and wherein the first cover and the second cover are connected.

2. The case according to claim 1 and further comprising one or more means for securing the portable electronic device on the inside of the first cover.

3. The case according to claim 1 or 2, further comprising means for setting up the portable electronic device inside the case.

4. The case according to one of the claims 1 to 3, wherein the adjustable fastener consists of two overlapping band-shaped parts.

5. The case according to one of the claims 1 to 4, wherein the two parts of the adjustable fastener are designed as hook and loop fasteners.

6. The case according to one of the claims 1 to 5, wherein the two parts of the adjustable fastener are each connected to the inside of the second cover via an elastic connecting element.

7. The case according to one of the claims 1 to 6, wherein the shape of the first and the second cover match the outer shape of the portable electronic device.

8. The case according to one of the claims 1 to 7, wherein the outer shape of the first and the second cover is rectangular.

9. Case for a portable electronic device according to claim 1, comprising:
a first rectangular cover 10, with
the first rectangular cover comprising the upright edges 11, 12, 13 and 14 at the each of the four corners, wherein
each of the four upright edges 11, 12, 13 and 14 has a bent rim directed towards the inside of the first rectangular cover, and
the four edges 11, 12, 13 and 14, with the bent rim, serve to accommodate and secure the portable electronic device 30 in the first rectangular cover 10 of the case;
a second rectangular cover 20, comprising
an adjustable fastener 21 on the inside, which consists of two overlapping band-shaped parts 22 and 23 that are detachably connected,
wherein the first rectangular cover 10 and the second rectangular cover 20 are connected.

10. The case according to claim 9, optionally comprising an additional upright edge 15 and/or 16 on each of the two short sides of the first rectangular cover 10.

11. The case according to claim 9, wherein the first rectangular cover 10 is divided into two parts, comprising
a back part 17 comprising the four upright edges 11, 12, 13 and 14 and optionally the upright edges 15 and/or 16 with bent rims for accommodating and securing the portable electronic device and a cut-out, preferably a trapezoidal cut-out; and
a connecting element 40 for fastening back part 17 to the second rectangular cover 20, wherein the outer shape and the dimensions of the connecting element 40 are designed so that the connecting element 40 fills the section of the back part 17.

12. The case according to claim 11, wherein the connecting element 40 comprises a first hinge 41 and second hinge 42.

13. The case according to claim 12, wherein the first hinge 41 and the second hinge 42 are constructed as a fold.

14. The case according to one of the claims 9 to 13, wherein the fastener 21, comprising the two band-shaped parts 22 and 23 on the inside of the second rectangular cover 20, is adjustable (in size).

15. The case according to one of the claims 9 to 14, wherein the fastener 21, comprising the two parts 22 and 23 on the inside of the second rectangular cover 20, is designed as a hook and loop fastener.

16. The case according to one of the claims 9 to 15, wherein the two parts 22 and 23, respectively, of the fastener 21 are connected to the inside of the second rectangular cover 20 via an extensible, preferably elastic, connecting element 24.

17. The case according to one of the claims 9 to 16, wherein the case may be attached to parts of the body, objects or devices with the aid of the fastener 21, consisting of the two parts 22 and 23, and the fastener is adjustable to the circumferences of these parts of the body, objects or devices.

18. The case according to one of the claims 9 to 17, wherein the inside of the second rectangular cover 20 has one or more groove-like depressions 25 and/or 26.

19. The case according to one of the claims 9 to 18, wherein the second rectangular cover 20 comprises a stretchable, preferably elastic, band 27.

20. The case according to one of the claims 9 to 19, wherein the second rectangular cover 20 comprises at least one upright edge 28 with a bent rim directed towards the inside of the second rectangular cover 20.

21. The case according to one of the claims 9 to 20, wherein the edge 28 with the bent rim directed towards the inside of the second cover 20 is used as a closure between the first rectangular cover 10 and the second rectangular cover 20.

22. The case according to one of the claims 9 to 21, wherein the first rectangular cover 10 is hinged on the second rectangular cover 20 and the stretchable band 27, for example as transport protection, may be stretched over the portable electronic device 30 or the outer side of the first rectangular cover 10.

23. The case according to one of the claims 9 to 22, wherein the back part 17 can be positioned at different angles by means of the connecting element 40, the hinges 41 and 42 and one of the groove-shaped depressions 25 or 26.

24. The case according to claim 23, wherein the groove-like depressions 25 or 26 on the inside of the second rectangular cover 20 is used to receive the lower edge of back part 17.

25. The case according to one of the claims 9 to 24, wherein the first rectangular cover 10 comprises as desired one or more cut-outs/openings 50 for additional functions and/or control elements of the portable electronic device 30.

26. The case according to one of the preceding claims, wherein the portable electronic device 30 is selected from a smartphone, a tablet PC, a flat screen TV, a CD or DVD player or a flat-screen TV.
